(19) United States
(12) Patent Application Publication
(10) Pub. No.: US 2016/0169450 A1
(43) Pub. Date: Jun. 16, 2016

(54) INSTALLATION AND MAINTENANCE OF A SUBMERGED CRYOGENIC PUMP

(71) Applicant: Cryogenic Vessel Alternatives, Inc., Baytown, TX (US)

(72) Inventor: Hector Villarreal, Houston, TX (US)

(73) Assignee: Cryogenic Vessel Alternatives, Inc., Baytown, TX (US)

(21) Appl. No.: 15/050,255

(22) Filed: Feb. 22, 2016

Related U.S. Application Data
(63) Continuation of application No. 12/905,562, filed on Oct. 15, 2010.

(51) Int. Cl. F17C 13/08; F17C 7/02

(52) U.S. Cl. CPC F17C 13/083; F17C 7/02

(57) ABSTRACT

A method and system for installing and maintaining submerged cryogenic pumps is disclosed. The submerged pump may be positioned within a product storage vessel. Alternatively the submerged pump may be positioned within a product storage vessel with a sump that is integral with and not removable from the vessel. The pump may used for the movement of products, such as cryogenic liquids, including but not limited to, nitrogen, argon, ethylene, natural gas, nitrous-oxide, carbon-monoxide, hydrogen, helium, and carbon-dioxide. Superior results are obtained with respect to access, maintenance and handling of the pump within a product storing vessel.

### BACKGROUND OF THE INVENTION

1. Field of the Invention

This invention generally relates to the field of submerged cryogenic storage pumps.

2. Description of the Related Art

Submerged pumps are used in numerous applications in many industries. Some of the advantages of submerged pumps include: (a) no seal (and therefore no leakage) around the pump motor drive shaft; (b) lubrication of the pump bearings by the liquid in which the pump is submerged; (c) more time between pump maintenance and/or replacement; (d) in cryogenic applications, when the pump is mounted vertically in a separate external sump container as in the prior art, less required Nominal Suction Head Pressure (“NPSH”) (NPSH is the pressure the liquid exerts at the pump inlet from the column height of the liquid itself contained within the vessel) due to the artificially generated pressure in the space above the cryogen used to prevent the cryogen from boiling; and (e) in cryogenic applications, elimination of the need to wait for the pump to cool down before discharging the product. Some of the disadvantages with submerged pumps include: (a) higher initial purchase costs for both the pump and the prior art external sump container; (b) longer time and higher costs for initial installation; (c) longer down times for maintenance; and (d) for cryogenic applications, although submerged pumps are used for flammable products, such as liquid natural gas and liquid ethylene (there is no air or oxygen in the product storage vessel that could support combustion), they are not used for liquid oxygen service, due to the inherent danger for a fire. Oxygen is not flammable, but it is a potent oxidizer, so it makes fires burn aggressively.

In prior art cryogenic applications, a submerged pump has been used to discharge product from a product storage vessel. A product storage vessel includes a product dispensing vessel, a bulk storage tank, a mobile delivery tank, a transportable bulk supply tank, and/or a dewar flask. An example of a submerged pump is an ACD pump model AC32 supplied by Cryogenic Industries of Marietta, Calif.

In the prior art, a submerged pump has been mounted below the product storage vessel in a separate external sump container that is removable from the product storage vessel, as shown in FIG. 3. The submerged pump is positioned in the sump container vertically in reference to the ground. For cryogenic applications, it is critical that each of the product storage vessel and the removable sump container be vacuum sealed and insulated. Submerged pumps are powered by an electric motor that is coupled to the pump and is also submerged in the liquid. An electrical pass-through/bulk head fitting is used to route power to the electric motor.

One problem with the prior art system and method is the lack of quick and easy access to the pump for installation and/or maintenance. Submerged pumps need regular maintenance, although less frequently than for non-submerged pumps. In cryogenic applications, the maintenance process is time consuming, as both the product storage vessel and the separate external sump container must be warmed, then the vacuum broken to allow the space between them to achieve ambient pressure, the sump container removed, maintenance on the pump performed, the sump container re-attached, the critical vacuum re-achieved in the product storage vessel and the sump container, and both purged and cooled back down. An acceptable vacuum is below 10 microns of mercury when the product storage vessel is warm.

Another problem with the prior art is that the typical external vertical sump container is heavy, weighing several hundred pounds. The sump container weight creates problems for handling during installation, maintenance, and for transportation of the product dispensing vessel since U.S. Department of Transportation (DOT) load restrictions may limit the amount of product allowed in the vessel, and hence sold per load. Weight is generally not a factor for stationary mounted storage and dispensing tanks. However, the separate sump container is expensive, often costing as much as the submerged pump.

The vertical external sump container also creates difficulties with ground clearance during transportation and installation. Further, the connection between the external sump container and the product storage vessel is not vacuum insulated. Therefore, temperature gain (or leakage) occurs through the connection, allowing ice to form. This results in problems with the connection, among other things.

Therefore, a need exists for a method and system to mount submerged pumps so as to provide easier access for installation and maintenance, to minimize or eliminate the additional weight of the sump container to the product storage vessel, to lower expense, to eliminate difficulties with ground clearance, and to eliminate undesirable heat gain.

### BRIEF SUMMARY OF THE INVENTION

A method and system is disclosed for positioning a submerged pump inside a product storage vessel. A manway provides easy access for maintenance. A method and system is also disclosed for installing a submerged pump in a sump that is integral with and not removable from a product storing vessel. Further, a method and system is disclosed for installing a submerged pump horizontally or at non-vertical angle in an external removable sump container positioned with a product storage vessel.

### BRIEF DESCRIPTION OF THE DRAWINGS

A better understanding of the present invention can be obtained with the following detailed descriptions of the various disclosed embodiments in the drawings, which are given by way of illustration only, and thus are not limiting the present invention, and wherein:

FIG. 1A is a prior art elevational view of a separate removable sump container, with the submerged pump (not shown) mounted vertically inside the sump container.

FIG. 1B is a prior art isometric view of a submerged pump.

FIG. 2 is a prior art elevational section view of a submerged pump mounted in a vacuum insulated external removable sump container.

FIG. 3 is a prior art schematic elevational view of an external sump container mounted vertically below a product storing vessel, with a submerged pump (not shown) mounted vertically internal to the sump container.

FIG. 4 is a schematic elevational view of a submerged pump positioned in a product storing vessel.

FIG. 5 is a schematic elevational view of a submerged pump positioned horizontally in a sump that is integral with and not removable from a product storing vessel.

FIG. 6 is a schematic elevational view of a submerged pump installed at a non-vertical angle in a sump that is integral with and not removable from a product storing vessel.

FIG. 7 is a schematic elevational view of a submerged pump installed horizontally in an external removable sump container positioned below a product storing vessel.

FIG. 8 is a schematic elevational view of a submerged pump installed at a non-vertical angle in an external removable sump container positioned below a product storing vessel.

### DETAILED DESCRIPTION OF THE INVENTION

Generally, the present invention involves a method and system for installing and maintaining submerged pumps. This invention applies to the installation and mounting of submerged pumps in all types of product storage tanks, vessels, and containers, and is not limited only to those used in the cryogenic industry. Typical cryogenic tanks may be vacuum insulated transport trailers, truck mount tanks, off-shore vessels, International Organization for Standardization/International Maritime Organization (ISO/IMO) containers, bulk storage tanks, and others. Typical liquids to be stored and pumped include, but are not limited to, such cryogenic liquids as nitrogen, argon, ethylene, natural gas, nitrous-oxide, carbon-monoxide, hydrogen, helium, and carbon-dioxide.

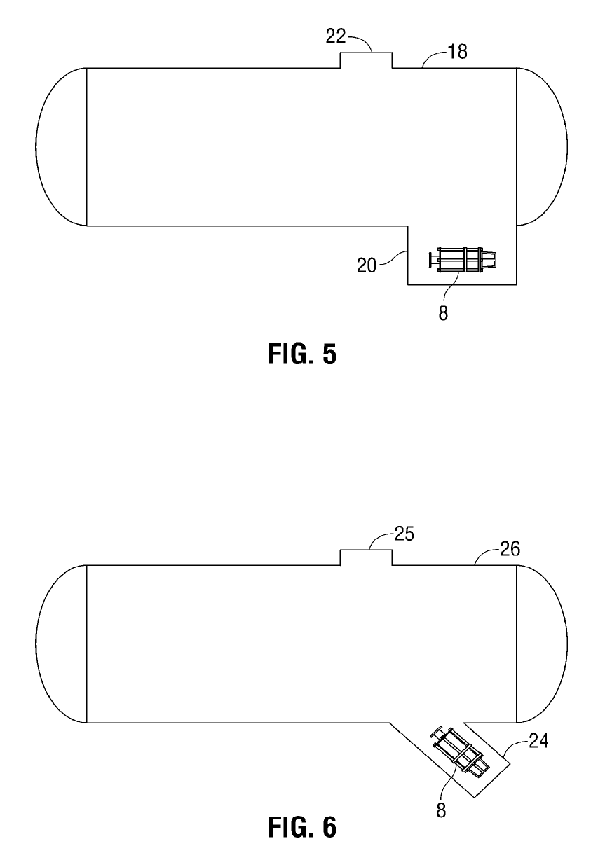

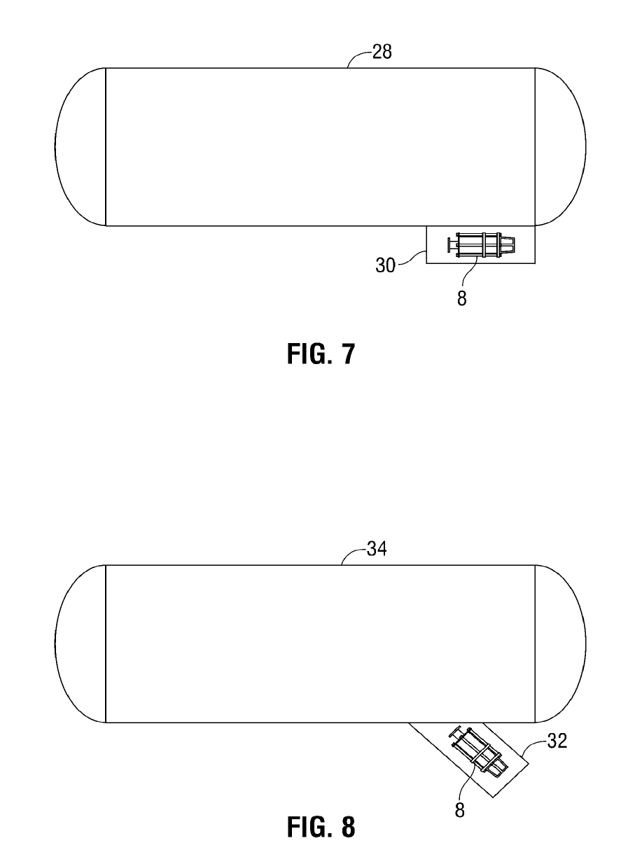

This invention contemplates the installation of submerged pumps (1) inside a product storing vessel (FIG. 4), (2) substantially horizontally (FIG. 5), or at an angle (FIG. 6) in a sump integral with and not removable from a product storage vessel, and (3) horizontally (FIG. 7), or at a non-vertical angle (FIG. 8) in an external sump container mounted with a product storage vessel. Submerged pumps may be designed with bearings suitable for horizontal or angled mounting. As can now be understood, this invention generally addresses the installation and mounting of submerged pumps in a non-vertical position. However, it is contemplated in the invention that a submerged pump may be mounted vertically inside a product storage vessel without a sump or within a product storage vessel with an integral non-removable sump.

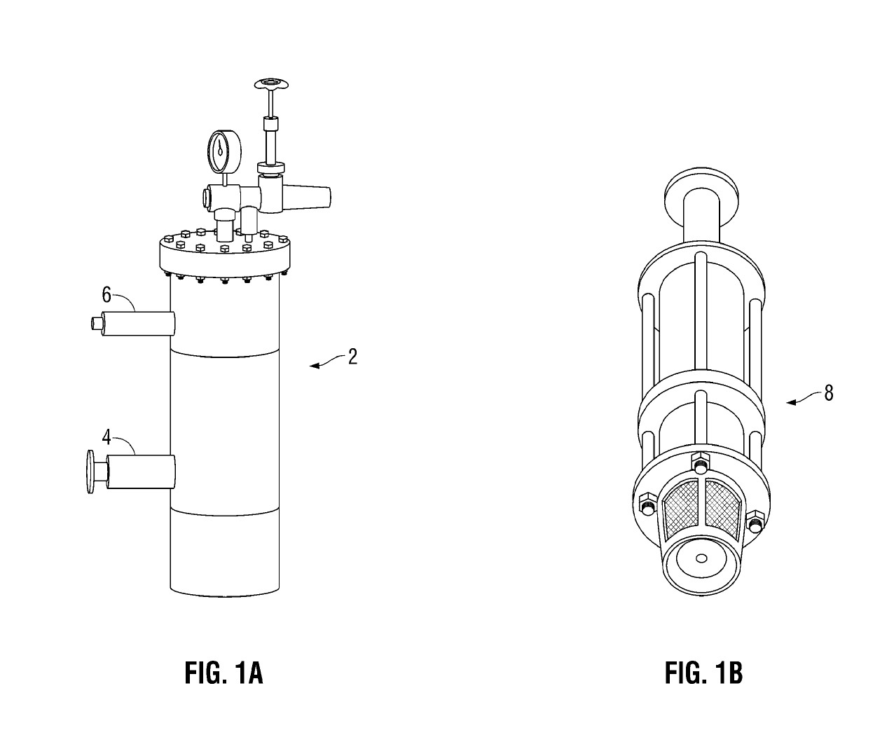

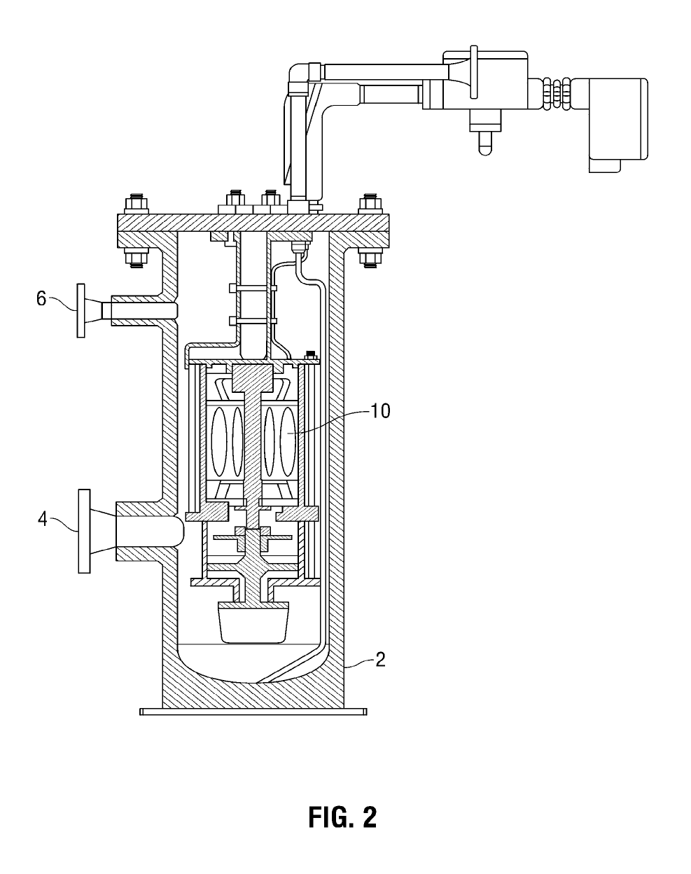

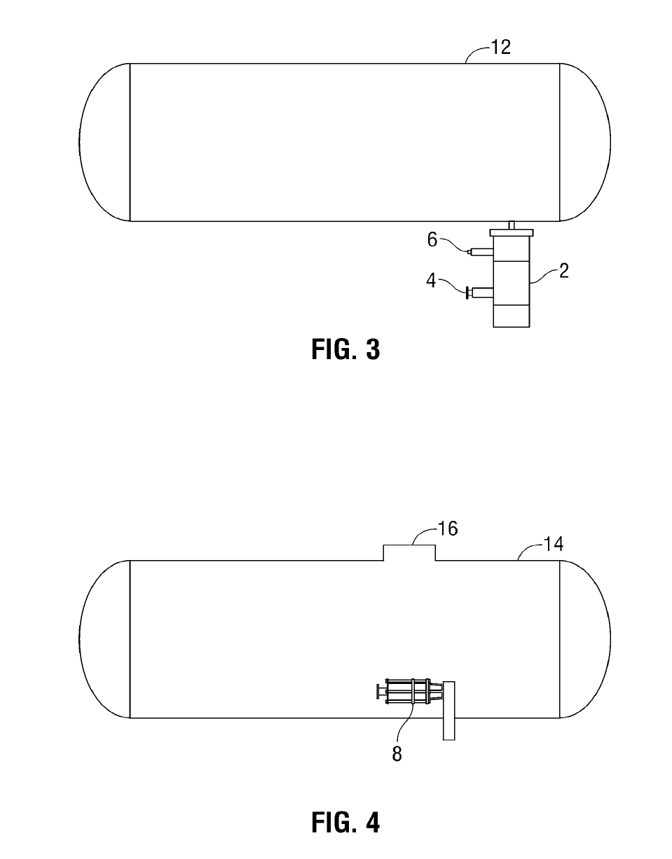

FIGS. 1A, 2, and 3 show the prior art installation of a submerged pump. Turning to FIG. 1A, external removable sump container 2 may be an ASME Code Vacuum Jacketed Pressure Vessel and Cover. Separate removable sump container 2 is not a product storing vessel. A submerged pump 8, shown in FIG. 1B, is mounted vertically within sump container 2. An electric pass through line 6 may be used to route power to the electric motor 10 within the submerged pump 8. As can now be understood, the height of the external sump container 2 may create clearance problems below the product storage vessel 12. Moreover, the sump container 2 adds weight to the system. Further, the sump container 2 must be vacuum sealed with the product storage vessel 12, and the vacuum in both the sump container 2 and the vessel 12 must be broken before maintenance, and re-evacuated after maintenance, causing delay.

Turning to FIG. 4, in one embodiment of the present invention, the submerged pump 8 may be positioned within the product storage vessel 14, thereby eliminating the need for the sump container 2. As the pump 8 must be submerged, mounting it horizontally or at an angle other than vertical (in relation to the tank bottom or ground) results in a lower liquid level being required in the product storage vessel 14 to cover the pump motor and bearings for lubricating and cooling. However, it is also contemplated that the submerged pump 8 may be mounted vertically within the product storage vessel 14. Artificially generated head pressure above the cryogen may be used to meet the minimum NPSH requirements for the submerged pump 8. The submerged pump 8 may be accessed for mounting and maintenance via a manway 16 designed and built into the product storing vessel 14.

As can now be understood, since there is a common vacuum space within the product storage vessel 14 for the pump 8, there is no heat gain as in the prior art at the connection between the external sump container and the product storage vessel as the connection has been eliminated. Moreover, there is only one vessel 12 to warm, break the vacuum, and re-evacuate for maintenance of the pump 8, significantly shortening maintenance time. Also, the manway lid in a cryogenic vessel, such as vessel 12, may be removed without breaking the vacuum. The lid itself may not be vacuum insulated. The vacuum is maintained all around the manway opening. Thus, only the vessel 12 needs to be warmed and purged with air prior to entry by a human. When maintenance is complete, the manway lid may be re-bolted, and the vessel 12 cooled and purged as desired.

Turning to FIG. 5, in an alternative embodiment, a product storage vessel 18 may be designed with a built-in “bulge” sump 20, integral with and not removable from the product storing vessel 18, in which the submerged pump 8 may be mounted horizontally in relation to the ground, or at some other angle. The submerged pump 8 may be accessed for mounting and maintenance via a manway 22 designed and built into the product storing vessel 18. In another embodiment shown in FIG. 7, it is contemplated that the sump 20 may be designed as a separate vacuum insulated sump container 30 connected to a product storing vessel 28, with the submerged pump 8 mounted horizontally or at some other angle.

Turning to FIG. 6, in another embodiment, a sump 24 or “sump-like” protrusion is shown at an angle to, and common with, the product storage vessel 26, so as to keep the submerged pump 8 low in the product storage vessel 26, but still providing improved ground clearance and improved NPSH. Again, the sump 24 is not removable from the vessel 26. A manway 25 is provided for access. In another embodiment shown in FIG. 8, the angled sump 24 may be designed as a separate vacuum insulated sump container 32 connected to a product storing vessel 34, with the submerged pump 8 mounted at an angle.

It is contemplated that more than one submerged pump 8 may be positioned using any embodiment of the invention. It is also contemplated that the product storage vessels (12, 14, 18, 26) shown in FIGS. 4-8 may have an inner vessel and an outer vessel with a vacuum space between for insulation. It is contemplated that the integral non-removable sump (20, 24) shown in FIGS. 5-6 may be in the inner vessel only, or alternatively, in both the inner vessel and the outer vessel of product storage vessels (18, 26).

As can now be understood, the advantages to the embodiments shown in FIGS. 4-6 include convenient access for maintenance via the manway. Maintenance may be done in less time since the vacuum of the external removable sump container does not have to be broken. Further, there is no need to re-evacuate the sump container. The vacuum is a critical item on a cryogenic product storage vessel. Since the sump container is eliminated, no additional weight is added with the product storing vessel, thereby allowing more product to be transported. Also, the prior art problem of heat gain and ice formation at the connection of the external sump container to the product storing tank is eliminated as there is no external sump. Finally, with all embodiments, the problem with ground clearance beneath the product storing vessel is either eliminated (FIGS. 4-6) or reduced (FIGS. 7-8), making transportation on a truck or other carrier (not shown) easier. Consequently, the invention provides superior results for storing and transporting products.

The foregoing disclosure and description of the invention are illustrative and explanatory thereof, and various changes in the details of the illustrated apparatus and system, and the construction and the method of operation may be made without departing from the spirit of the invention.

What is claimed is:

1. A method for performing maintenance on a mobile system for dispensing a cryogenic product, the system comprising:
a cylindrical shaped container configured to store a cryogenic product, said container having an upper horizontal cylindrical wall and a lower horizontal cylindrical wall;
a manway disposed on the upper horizontal cylindrical wall; and
a pump suitable for immersion in the cryogenic product and located within the container along the lower horizontal cylindrical wall; and
the method comprising:
opening the manway to expose the interior of the container;
performing maintenance on the pump while the pump remains in the container; and
closing the manway after the maintenance has been performed.

2. The method of claim 2, further comprising:
purging the container of with air prior to opening the manway.

3. The method of claim 3, further comprising:
warming the container prior to purging.

4. The method of claim 2, further comprising:
cooling the container after closing the manway.

5. The method of claim 2, wherein the product is a cryogenic liquid.

6. The method of claim 2, wherein the product is a liquid natural gas.

7. The method of claim 5 wherein the cryogenic liquids is nitrogen, argon, ethylene, natural gas, nitrous-oxide, carbon-monoxide, hydrogen, helium, carbon-dioxide.

8. The method of claim 1 where in the cylindrical tank is supported on transport trailers or truck mount tanks.
